(19) United States
(12) Patent Application Publication
(10) Pub. No.: US 2007/0168369 A1
(43) Pub. Date: Jul. 19, 2007

(54) User interface for a portable electronic device

(75) Inventor: John R. Bruns, Portland, OR (US)

Correspondence Address: ALLEMAN HALL MCCOY RUSSELL & TUTTLE LLP, 806 SW BROADWAY, SUITE 600, PORTLAND, OR, 97205-3335, US

(73) Assignee: CompanionLink Software, Inc., Portland, OR (US)

(21) Appl. No.: 11/649,699

(22) Filed: Jan. 3, 2007

Related U.S. Application Data
(60) Provisional application No. 60/756,485, filed on Jan. 4, 2006.

(51) Int. Cl. G06F 7/00

(52) U.S. Cl. 707/100

(57) ABSTRACT

A method and user interface for displaying and enabling access to data items stored on a handheld electronic device, the data items being organized in hierarchical menus associated with characteristics of the data items. A navigational feature is included which actuates direct display of a top-level menu from any of a plurality of user interface menus, without requiring navigation through any intermediate menu, even when commencing from multiple menu layers below the top-level menu.

### CROSS REFERENCE TO RELATED APPLICATION

The present application claims priority to U.S. Provisional Patent Application Ser. No. 60/756,485 filed Jan. 4, 2006, which is hereby incorporated by reference in its entirety for all purposes.

### BACKGROUND

The present description relates to an interactive user interface which enables a user to access a data item stored in a memory location of an electronic device. As technology improves, music players and other portable devices are becoming smaller and more powerful, and storage capacities are increasing dramatically. Such devices typically have small display screens and/or limited physical space for buttons or other user controls to operate the interface. Also, it is often desirable that an operator be able to perform certain functions with the user interface by activating a minimum number of buttons/controls, often with a single hand.

### BRIEF DESCRIPTION OF THE DRAWINGS

FIG. 1 depicts an example embodiment of an electronic computing device.

FIG. 2 schematically depicts a processing block diagram that may be employed in the electronic computing device shown in FIG. 1.

FIG. 3 depicts exemplary menu screens of a hierarchical menu system employed in an electronic device, and particularly illustrated in the context of a portable music player.

FIG. 4 depicts an exemplary hierarchical menu system in an electronic device.

FIG. 5 shows a flow chart, illustrating an exemplary method to display and navigate a hierarchical menu system in an electronic device.

### DETAILED DESCRIPTION

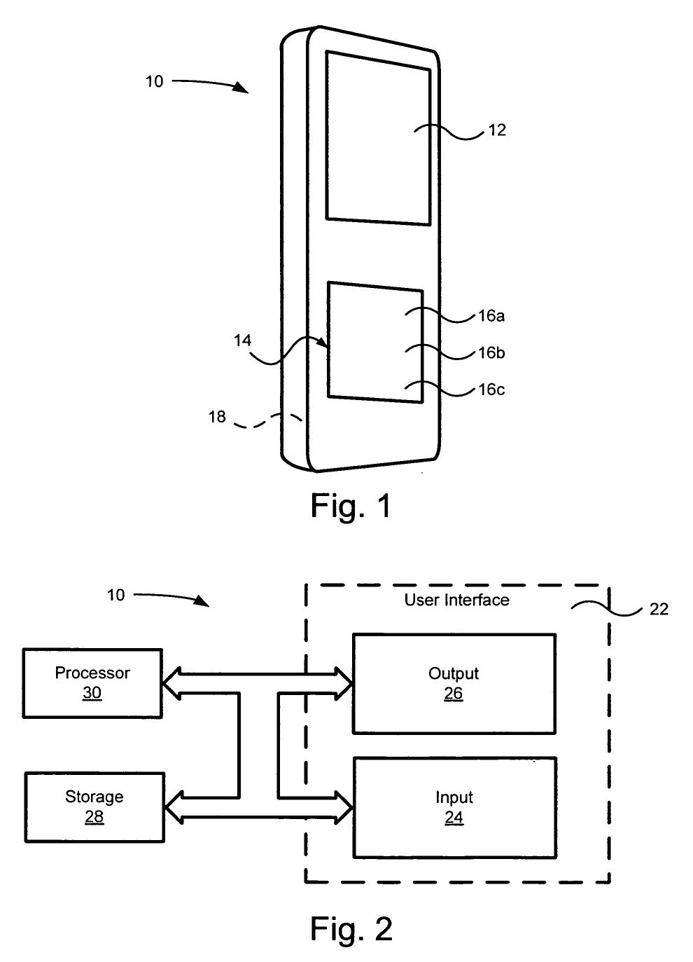

FIG. 1 depicts an example embodiment of an electronic computing device. The electronic device may be a handheld electronic device 10 which stores data items to be selected/accessed by a user. More particularly, in one example, the device is a portable music player (e.g., an MP3 player) configured to allow a user to select and play back songs stored in the device. Although the portable music player example will be discussed at length in the present description, it should be appreciated that many of the features discussed herein are applicable to a variety of electronic device user interfaces, and particularly to devices with small display screens and limited space for buttons or other user controls.

As will be described at length below, the portable device includes a user interface configured to enhance the ability of a user to efficiently navigate hierarchically organized data items stored on the device. In such a system, the user typically navigates upward and downward through a hierarchical menu system to select and access data items having desired characteristics.

For example, the user interface employed on the widely-known Apple Ipod music players allows the following exemplary operation: (1) from a “home” menu screen displaying GENRES, ALBUMS, ARTISTS and other selections, the user selects GENRES; (2) this selection causes display of a lower, subsidiary menu displaying COUNTRY, CLASSICAL, FOLK and other genres of the songs available on the device; (3) the user selects FOLK, so as to cause display of a still lower menu displaying specific album titles for songs on the device that are in the folk genre. Continuing with this example, the user eventually is able to select, through further menus, a desired album title, and then a desired song for playback.

In small portable devices, use of this example menu system requires repeated and frequent use of interface actuators to move upward and downward through the menus. In the given example, once FOLK is selected at step (3), the menu system branches in a way that requires the user to navigate back up to the genre menu in order to select COUNTRY or another genre other than FOLK. Likewise, once a particular folk album title has been selected, the user must navigate back up to the listing of folk albums to select a different one of the folk albums.

In various embodiments described herein, an advantageous interface feature is employed to make navigation and item selection more efficient. In particular, according to one example, the interface includes an actuator that enables direct and immediate access to a top-level menu of the interface. In the above example, the menu listing the available genres is a top-level menu, because it lists all of the genres represented in the songs that are stored on the device. Implementation of the described feature in the above exemplary system allows direct access to another top-level menu (e.g., a menu showing all available artists) without having to go through the “home” menu or other intervening menu or displayed screen. Furthermore, the direct access feature described herein may be employed at a variety of different levels in a hierarchal system. For example, the actuator may be employed to cause immediate display of a top-level menu from a menu produced by multiple downward navigations (e.g., by selecting a particular genre, a particular artist in that genre, a particular album by that artist, etc.). In other words, from a screen displaying song titles having a selected genre, artist and album (three levels below the top-level menu), the actuator could cause direct display of the top-level menu showing all of the albums on the device.

Turning now more specifically to the Figures, the operating environment will be described along with further examples. Continuing with FIG. 1, handheld electronic device 10 may include a screen 12. Screen 12 may be used to display a menu system that forms part of the user interface of the device. The user interface and menu system employs a hierarchical structure as referenced above and described in more detail below. Screen 12 may be used to display different menus successively in response to a user selection. Ultimately, the interface enables a user to navigate the menu system and eventually select a data item (e.g., a song to play).

Device 10 may also include various user controls 14. In the context of a music player, these controls may include volume controls, playback controls (fast forward, rewind, track advance, previous track) and the like. These are but examples—a variety of different controls may be employed. In addition, the controls may be implemented with a keypad, touch-screen interface, scroll wheel or any other suitable input mechanism.

For music device implementations and a variety of other applications, controls 14 commonly include a navigational actuator or controls 16. Navigational controls 16 may be configured to enable selection of items from a displayed menu, and/or access to different layers or levels of the hierarchical menu system. In some embodiments, navigational controls 16 may include an up actuator 16a, a down actuator 16b, and a top-level actuator 16c. Up actuator 16a is configured to enable access to an upper-level menu from a current menu. For example, in a music player, the up actuator might be activated to move upward from a menu showing all of the albums in a selected genre to a menu showing all available genres on the music player. Down actuator 16b is configured to enable access to a lower-level menu from the current menu. In the example just discussed, the down actuator could be used to move downward from the full listing of available genres to the menu showing all albums in a selected one of the genres (e.g., all jazz albums). Top-level actuator 16c is configured to display one of a plurality of top-level menus directly from any current displayed menu, as will be described in detail below along with further aspects of an exemplary hierarchical menu system and interface.

Selection actuators are typically also included to enable selection of a particular item from among a variety of items displayed on a menu screen. For example, on a screen listing JAZZ, ROCK AND ROLL and POP as available genres, the selection actuator (e.g., keypad, scroll wheel, touch-sensitive screen, etc.) would allow the user to highlight one of those genres, and then the “down” actuator would be used to select the genre and cause display of a lower menu, such as a listing of all albums in the jazz genre.

In keypad and other implementations, the different controls may be mapped to different physical actuators depending on the use scenario. For example, a given keypad button might perform a first function at a first type of menu screen, and a second, different function at another menu screen. Such mapping may be employed to increase functionality available with a given number of physical controls.

Handheld electronic device 10 may also include a storage device 18. Storage device 18 may include a memory location configured to store the data items in a predetermined organizational structure that can be navigated by the user interface. The data items typically have associated tags or characteristics. Returning again to the music player example, the album, artist, genre and title of a song (i.e., data item) are characteristics of that song. Still other characteristics may be employed, such as the song's presence on a playlist, a favorites list, etc. The songs stored in storage device 18 are accessible in response to selection of these characteristics from a user interface.

FIG. 2 schematically depicts a block diagram of a data processing system 20 that may be employed in the electronic device shown in FIG. 1. As shown, data processing system 20 may include a user interface 22. User interface 22 may include an input 24 and an output 26. In some embodiments, input 24 may include a screen, audio output, etc. In some embodiments, output 26 may include actuators, keypad, etc. One typical function of user interface 22 is to enable a user to select a data item stored in a memory location. For example, in some embodiments, the user may use actuators to select the data item through a display on the screen.

Data processing system 20 may also include a storage 28 and processor 30 configured to provide overall system and processing control via a bus 32 or like mechanism interconnecting the various components of the device.

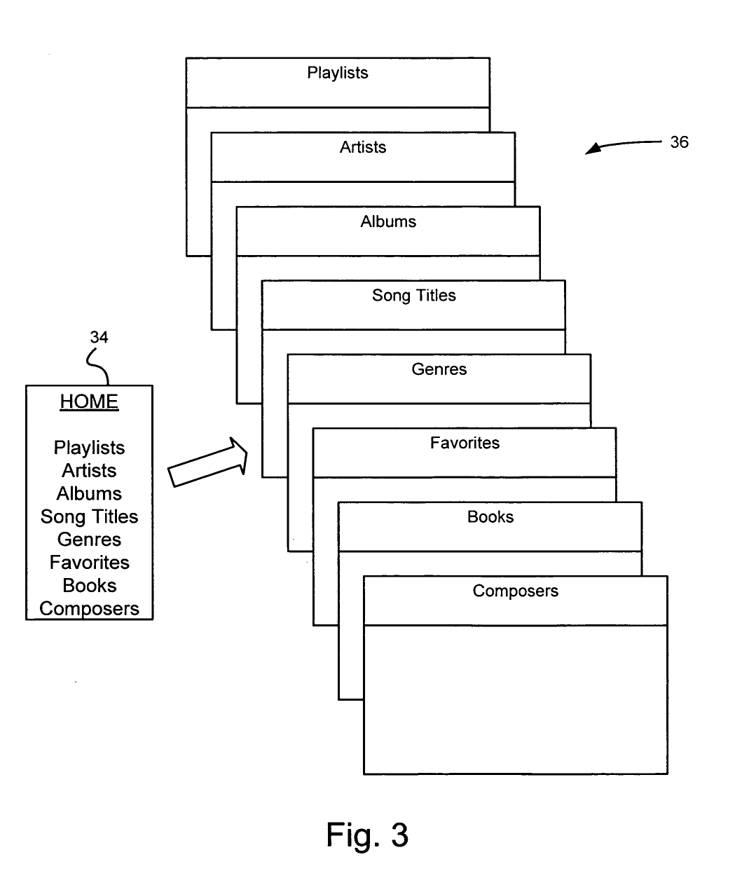

FIG. 3 shows a home menu 34 and a plurality of top-level menus 36 in an exemplary hierarchical menu system. In some embodiments, data items in the handheld electronic device may be organized in a top-down hierarchical structure in accordance with one or more characteristics associated with data items. The hierarchical menu system may include menus at different levels in a hierarchy. Typically, the hierarchical menu system includes a plurality of top-level menus 36 one level below home menu 34. At the home level, the categories of characteristics are displayed, e.g., the user can choose to view available genres, artists, etc. Then, at the top-level, each top-level menu is configured to organize data in accordance with a selected category of characteristic.

In the depicted embodiment, the top-level menus are illustrated in the context of a portable music player. As shown in FIG. 3, a plurality of top-level menus 36 may include the following menus: Playlist (showing a listing of pre-defined track playlists), Artists (showing a listing of available artists), Albums (showing available albums), Song Titles (available tracks), Genres (available genres), Favorites (listing of favorite tracks), Books (listing of audiobook tracks), Composers (available composers), etc. As discussed above, each top-level menu is characterized or organized by one characteristic of the data items that are stored on the device. For example, the top-level menu Genres is characterized by genre, meaning that the menu displays a list of available genres (e.g., jazz, rock and roll, etc.). In this case, since the menu is a top-level menu, the listed genres represent the genres of all of the songs stored in the system, as will be discussed in more detail below. Likewise, Playlist, Artists, Albums, Titles, Favorites, Books, and Composers are characteristics upon which other top-level menus may be organized.

At the top-level menus, data items are accessible by allowing user-selection of a first characteristic. However, data items accessible from the top-level menus are not sorted out or filtered by any characteristic. Thus, from any one of the top-level menus, a user may access any of the data items (e.g., songs) stored in the electronic device. In other words, a user can access any desired data item on the electronic device from the top-level menu itself or through a selection at a lower-level menu in the hierarchy under the selected top-level menu.

A user interface may display the plurality of top-level menus in various ways. In one embodiment, a list of a plurality of top-level menus may be displayed on a screen. A user may select one particular top-level menu from the list, which produces a screen displaying the selected top-level menu. In another embodiment, instead of the initial listing of the plurality of top-level menus, the user interface defaults to one of the plurality of top-level menus.

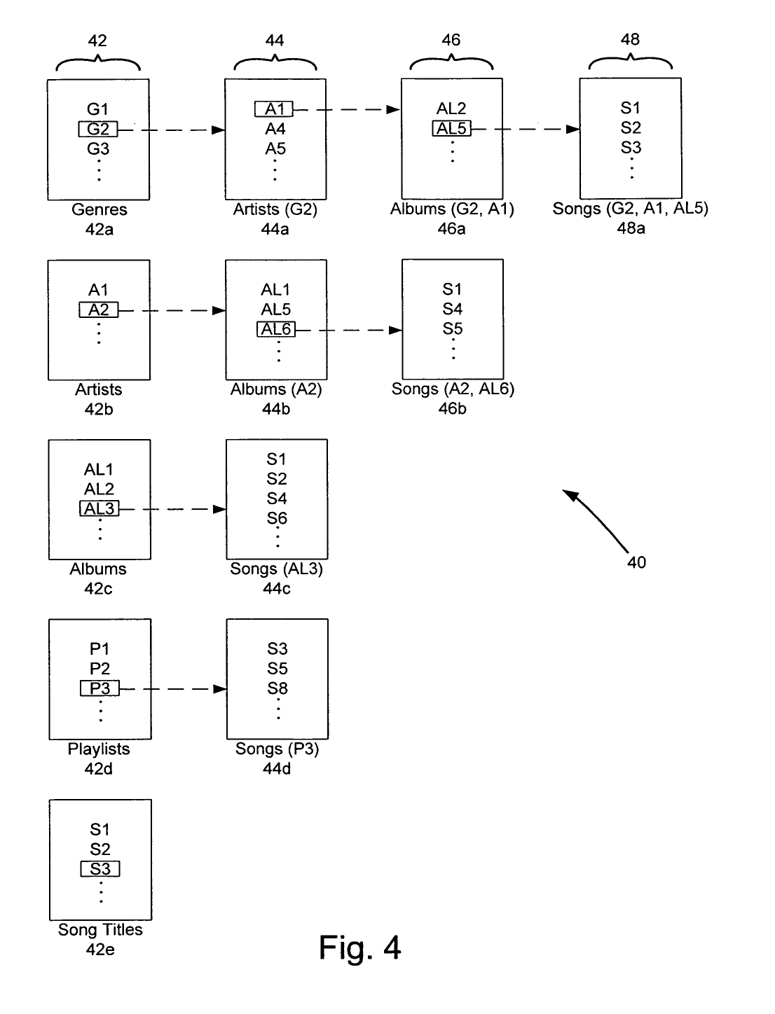

The overall structure of an exemplary top-down hierarchical menu system will be described with reference to FIG. 4. In the embodiment depicted in FIG. 4, a hierarchical menu system 40 may include a plurality of top-level menus 42. The hierarchical menu system 40 may also include successive hierarchical levels, such as second-level menus 44, third-level menus 46, or fourth-level menus 48. A second-level menu is one layer deeper in the hierarchy than a top-level menu; a third-level menu is one layer still deeper, etc. Data items accessible from the second-level menu (i.e., directly from a second-level menu or from a menu under the second-level menu) are sorted/restricted by a first characteristic that is selected from the top-level menu. In other words, all of the data items accessible from the displayed second-level menu share a common characteristic: they all have the characteristic which was selected at the top-level menu. For example, if the first level menu lists a number of different artists, and the user selects the artist “The Beatles,” then all of the tracks accessible from the resulting second-level menu will be songs by The Beatles. Thus, data items accessible from the second-level menu typically are fewer in number than those accessible from the top-level menu.

Likewise, the third-level menus are one layer deeper, and data items accessible from the third-level menus are restricted to items sharing both of the characteristics selected at the preceding top-level and first-level menus. The fourth-level menus are deeper still, and the items accessible from the fourth-level menus share three characteristics, i.e., those selected from the preceding three menus.

From any of the top-level menus 42, a user interface (e.g., user interface 22 in FIG. 2) enables a user to select a data item from all available data items stored in the electronic device. For example, in the music player embodiment of FIG. 4, top-level menus 42 include Genres, Artists, Albums, Playlists, Song Titles, etc. Top-level menu 42a enables access to all songs in the music player and shows the available genres of those songs: G1, G2, G3, etc. In one example, the listed genres G1, G2, and G3 may include “hip hop,” “rock and roll” and “jazz”, respectively.

The user interface may enable the user to access a deeper layered menu under the Genres top-level menu 42a. In one example, selecting a particular genre (e.g., G2) from top-level menu 42a may cause display of another screen listing all artists in the selected genre (G2) as shown in second-level Artists menu 44a. All songs accessible from the second-level menu 44a have a shared characteristic, namely they are all of Genre G2. Songs at the second-level menus are sorted out or filtered by a first characteristic, Genres. Thus, songs accessible at the second-level menus are less than songs available at the top-level menu 42a. The second-level menu 44a allows selection of an additional characteristic—in this case artists, more particularly, in this example, artists, A1, A2, A3, etc.

Continuing with FIG. 4, the user interface may likewise enable access to deeper menu layers under the Artists second-level menu 44a. For example, selecting a particular artist (e.g., A1) from second-level menu 44a causes display of third level menu 46a, which lists all albums by artist A1, e.g., AL2, AL5, etc. Songs accessible from third-level menu 46a all have two shared characteristics, i.e., genre G2 and artist A1.

Third-level menu 46a enables access to a still deeper menu—fourth-level menu 48a. For example, album AL5 is selected at the third-level menu 46a to cause display of fourth-level menu 48a, which lists all the songs, S1, S2, S3, etc. on album AL5. Songs at fourth-level menu 48a share three characteristics, G2, A1 and AL5.

Similar hierarchical navigation may occur from any of the other top-level menus. In particular, still referring to FIG. 4, top-level menu 42b enables the user to select a particular artist to access a deeper “Albums” menu 44b under artists top-level menu 42b. In the depicted embodiment, top-level menu 42b allows selection from various artists, A1, A2, A3, etc. Selecting a particular artist (e.g., A2) causes display of the second-level menu 44b, listing available albums by the artist A2, e.g., AL1, AL5, AL6, etc. Songs accessible from second-level menu 44b all share one characteristic, i.e., artist A2. From second-level artists menu 44b, the user interface may further narrow the user's selection by displaying a deeper layered menu. In particular, selecting one of the listed albums (e.g., AL6) causes display of a third-level menu 46b, listing all songs on album AL6, more specifically S1, S4, S5, etc. Songs under third-level menu 46b share two characteristics, i.e., A2 and AL6.

Referring again to FIG. 4, from a top-level albums menu 42c, the user interface enables the user to access a deeper level under the Albums top-level menu 42c. For example, selecting a particular album (e.g., AL3) may cause display of a second level menu 44c, listing all songs S1, S2, S4, S6, etc. on the selected album, AL3. Songs under the second-level menu 44c share one characteristic, AL3.

Likewise, from a top-level playlists menu 42d, the user interface enables the user to access a deeper layered menu under the playlists top-level menu. For example, selecting a particular Playlist (e.g., P3) may cause display of a second-level menu 44d, showing all songs S3, S5, S8, etc. on the playlist, P3. Songs under the second-level menu 44d share one characteristic, P3.

Alternatively, a top-level menu, “Song Title”, may cause display of a list including all available songs stored in the music player. The user may select any song from the list. Even though menu 42e enables direct selection of songs and has no menu layers beneath it, menu 42e is nonetheless a top-level menu because it permits access to all of the songs stored on the device.

It will be appreciated that the hierarchical sequencing shown in Fig. is but one example, and other sequences may be employed. In particular, instead of the sequence shown at 42a and 44a, selection of a particular genre could produce a listing of albums, a listing of composers, or a listing of song titles. Indeed, layering and sequencing of the hierarchy may be performed in a variety of different ways.

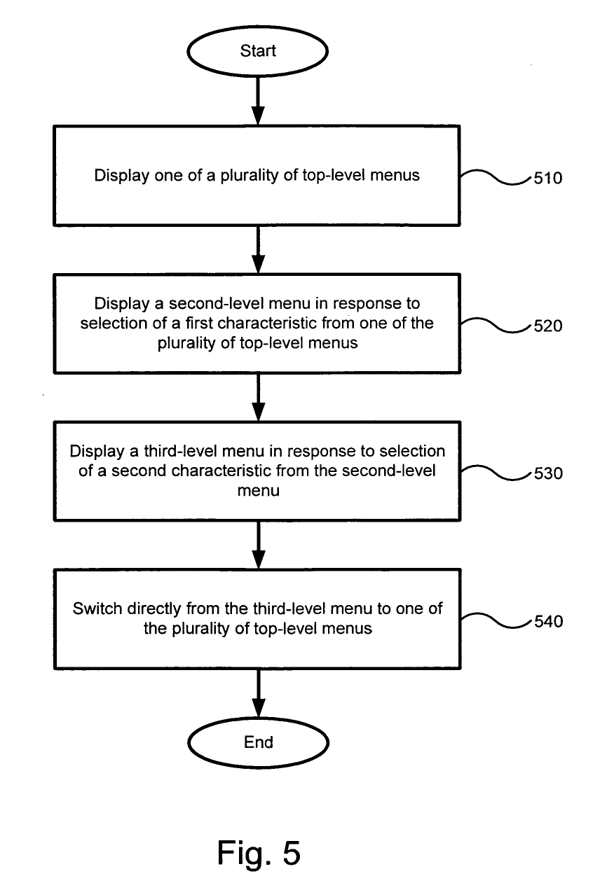

As previously discussed, songs or other data items in a hierarchical menu system may be accessible through a user interface. A method to display and navigate the hierarchical menu system will be described in FIG. 5. For purposes of clarity and illustration, the method will be described in the context of the handheld electronic device shown in FIGS. 1 and 2, though the method may be implemented on a variety of different devices. First, at 510, method 500 includes displaying one of a plurality of top-level menus on screen 12. In some embodiments, user interface 22 may display one top-level menu at a time. In one embodiment, top-level actuator 16c in user interface 22 may enable access to any of the top-level menus. For example, activation of top-level actuator 16c enables a user to display any of the plurality of top-level menus 42 as shown in FIG. 4. Display of a top-level menu allows the user to access all of the data items and eventually display a data item through further selection of characteristics (e.g., causing navigation to lower-level menus and eventual display and selection of a data item or items having the selected characteristics).

At 520, the method includes displaying a second-level menu in response to selection of a first characteristic from one of the plurality of top-level menus. The second-level menu is configured to enable access to the data items that have the first characteristic. In some embodiments, the second-level menu may be accessed from the top-level menu by down actuator 16b as shown in FIG. 1. Typically, actuation of down actuator 16b enables access to a lower-level menu that is deeper in the hierarchical menu system than the current displayed menu. The number of data items accessible from the deeper second-level menu is restricted by the first characteristic selected at the top-level menu. Thus, fewer data items typically are accessible from the second-level menu.

At 530, the method includes displaying a third-level menu in response to selection of a second characteristic from the second-level menu. The third-level menu is configured to enable access to the data items possessing both the first and second characteristics. Similar to step 520, in some embodiments, the third-level menu may be accessed from a higher-level menu by down actuator 16b. The number of data items in the third-level menu is further restricted by more characteristics.

Next, at 540, the method includes switching directly from the third-level menu to one of the plurality of top-level menus. In some embodiments, the switching may be implemented by activation of top-level actuator 16c. In one embodiment, the switching may include switching directly from the third-level menu to the top-level menu that initiates the navigation from the top-level menu to the current lower-level menus. In another embodiment, the switching may include switching directly from the third-level menu to a top-level menu that is different from the top-level menu that initiates the menu navigation.

It should be appreciated that a hierarchical menu system may include four or more levels. The top-level actuator enables switching from a menu at any level to a top-level menu without going through an intermediate menu between the currently displayed menu and the top-level menu. Further, it should be noted that up actuator 16b may be employed to navigate through each intermediate level menu to reach the top-level menu if desired. The top-level actuator may also be employed to jump directly from one top-level menu (e.g., albums) to another (e.g., artists) without having to navigate intermediately through a home screen (e.g., home menu 34).

Indeed, in some examples, the top-level actuator enables the user to go directly to a top-level menu no matter the depth of the current menu/screen in the hierarchical structured menu. Thus, the user can restart a search of a data item associated with a particular characteristic from all available data items in the handheld electronic device by simply activating the top-level actuator. In this way, a user's selection may be performed by the minimum number of button controls, thus enhancing the user's satisfaction with the electronic device.

While the present embodiments and method implementations have been particularly shown and described, those skilled in the art will understand that many variations may be made therein without departing from the spirit and scope of the invention. The description should be understood to include all novel and non-obvious combinations of elements described herein, and claims may be presented in this or a later application to any novel and non-obvious combination of these elements. Where claims recite “a” or “a first” element or the equivalent thereof, such claims should be understood to include incorporation of one or more such elements, neither requiring nor excluding two or more such elements.

What is claimed is:

1. A method for displaying data items in a handheld electronic device, the data items being organized in hierarchical menus associated with characteristics of the data items, the method comprising:
displaying one of a plurality of top-level menus, each top-level menu being configured to allow access to all of the data items;
displaying a second-level menu in response to selection of a first characteristic from said one of the plurality of top-level menus, the second-level menu being configured to enable access only to the data items having the first characteristic;
displaying a third-level menu in response to selection of a second characteristic from the second-level menu, the third-level menu being configured to enable access only to the data items having both the first and second characteristics; and
switching directly from the third-level menu to one of the plurality of top-level menus.

2. The method of claim 1, wherein the first characteristic is a musical genre.

3. The method of claim 2, wherein the second characteristic is a title of an album.

4. The method of claim 3, wherein the second characteristic is an artist name.

5. The method of claim 1, wherein the data items include songs.

6. The method of claim 1, wherein switching directly from the third-level menu to one of the plurality of top-level menus includes switching directly to said one of the plurality of top-level menus.

7. The method of claim 1, wherein switching directly from the third-level menu to one of the plurality of top-level menus includes switching directly to another of the plurality of top-level menus.

8. The method of claim 1, wherein displaying the hierarchical menus in response to said selection includes navigating the hierarchical menus with a user interface having a down actuator, an up actuator, and a top-level actuator, wherein the down actuator is configured to cause switching from the top-level menu to the second-level menu or switching from the second-level menu to the third-level menu; and wherein the up actuator is configured to cause switching from the third-level menu to the second-level menu or switching from the second-level menu to the top-level menu; and wherein the top-level actuator is configured to cause direct switching from the third-level menu to one of the top-level menus.

9. A system for displaying data items in a handheld electronic device, the system comprising:
a storage device configured to electronically store the data items;
a user interface operatively coupled with the storage device and configured to enable a user to access the data items, the user interface including:
a hierarchical menu system configured to display a plurality of menus showing characteristics of the data item, the plurality of menus including top-level menus and lower-level menus, where each top-level menu is configured so that all of the data items in the storage device are accessible from such top-level menu;
a down actuator configured to cause a display of the handheld electronic device to switch from displaying a higher-level menu of the hierarchical menu system to a lower-level menu of the hierarchical menu system;
an up actuator configured to cause the display to switch from displaying a lower-level menu of the hierarchical menu system to a higher-level menu of the hierarchical menu system;
a top-level actuator configured to cause the display to switch directly from any of the plurality of menus to one of the top-level menus without going through an intermediate menu.

10. The system of claim 9, wherein the data items includes songs.

11. The system of claim 9, wherein the characteristics includes one of a musical genre, an artist name, an album title and a song title.

12. The system of claim 9, wherein the user interface is configured to sequentially and successively display the top-level menus in response to repeated activation of the top-level actuator.

13. The system of claim 9, wherein at least one of the plurality of the top-level menus is configured to be associated with at least one characteristic.

14. The system of claim 9, wherein the user interface further includes a selection actuator to enable display of a menu having selected characteristics.

15. A user interface for accessing data items stored on a handheld electronic device, the data items having at least one associated characteristic and being accessible via a hierarchical menu structure having a plurality of menus, the user interface comprising:
a down actuator configured to cause downward branching from a current menu to a relatively lower layer menu of the hierarchical menu structure, where as a result of the lower menu layer requiring a relatively larger number of associated characteristics than the current menu, fewer of the data items on the handheld electronic device are accessible from the relatively lower layer;
an up actuator configured to cause reverse branching upward from a current menu to a relatively higher layer menu of the hierarchical menu structure, where as a result of the higher layer menu requiring a relatively smaller number of associated characteristics than the current menu, more of the data items on the handheld electronic device are accessible from the relatively higher layer; and
a top-level actuator configured to produce display one of a plurality of top-level menus directly from any one of the plurality of menus in the hierarchical menu structure without navigation through any intermediate menu, wherein such top-level menu is configured so that all of the data items are accessible from the top-level menu.

16. The user interface of claim 15, where the plurality of menus includes at least one menu for selecting a desired musical genre.

17. The user interface of claim 15, where the plurality of menus includes at least one menu for selecting a desired musical performing artist.

18. The user interface of claim 15, where the plurality of menus includes at least one menu for selecting a desired musical album title.

19. The user interface of claim 15, where the up actuator is configured to cause the user interface to directly switch from displaying a lower-level menu to one of the plurality of top-level menus.

20. The user interface of claim 15, where the up actuator is configured to cause the user interface to directly switch from displaying a first one of the plurality of top-level menus to a second one of the plurality of top-level menus without requiring navigation through a home menu.
